(19) United States
(12) Patent Application Publication
(10) Pub. No.: US 2011/0134338 A1
(43) Pub. Date: Jun. 9, 2011

(54) Control device, control method, and program

(75) Inventor: Kazuaki Toba, Kanagawa (JP)

(73) Assignee: Sony Corporation, Tokyo (JP)

(21) Appl. No.: 12/925,794

(22) Filed: Oct. 29, 2010

(30) Foreign Application Priority Data
Dec. 3, 2009 (JP) P2009-275814

(51) Int. Cl. H04N 5/44

(52) U.S. Cl. 348/734; 348/E05.096

(57) ABSTRACT

Disclosed herein is a control device connected to another control device through a network, the control device including: a transmission unit configured to transmit a command to the another control device through the network, a reception unit configured to receive the command transmitted from the another control device through the network, and a control unit configured to control a device to be controlled connected through an integrated cable, in which at least a video line, an audio line and a control line are integrated, based on the received command.

### CROSS-REFERENCE TO RELATED APPLICATION

The present application claims priority from Japanese Patent Application No. JP 2009-275814 filed in the Japanese Patent Office on Dec. 3, 2009, the entire content of which is incorporated herein by reference.

### BACKGROUND OF THE INVENTION

1. Field of the Invention

The present invention relates to a control device, a control method and a program and, more particularly, to, for example, a control device for controlling a connected device to be controlled through a network, a control method and a program.

2. Description of the Related Art

In the related art, for example, there is a High-Definition Multimedia Interface (HDMI) Consumer Electronics Control (CEC) control technology of enabling a control device such as a television receiver to control a device to be controlled such as a video recorder connected through an HDMI cable (for example, see Japanese Unexamined Patent Application Publication No. 2007-104138).

In the HDMI CEC control technology, the control device communicates a control command for controlling the device to be controlled through a CEC line included in the HDMI cable so as to control the operation of the device to be controlled. In addition, the CEC line is one of the signal lines included in an HDMI cable and represents a signal line for performing bidirectional communication with the device to be controlled.

### SUMMARY OF THE INVENTION

In the HDMI CEC control technology of the related art, the control device may communicate the control command only with the device to be controlled connected through the HDMI cable.

Accordingly, in this control device, there is a need for control even a device to be controlled connected through a network using the HDMI CEC control technology.

It is desirable to control a device to be controlled connected through a network.

According to an embodiment of the present invention, there is provided a control device connected to another control device through a network, the control device including: transmission means configured to transmit a command to the another control device through the network; reception means configured to receive the command transmitted from the another control device through the network; and control means configured to control a device to be controlled connected through an integrated cable, in which at least a video line, an audio line and a control line are integrated, based on the received command.

The network may be a Local Area Network (LAN) and the reception means may receive the command transmitted from the another control device through the LAN.

The integrated cable may be a High-Definition Multimedia Interface (HDMI) cable, and the control means may control the device to be controlled through a Consumer Electronics Control (CEC) line of the HDMI cable line based on the received command.

The command may be a recording command for instructing the recording of content, and the control means may control the device to be controlled and start the recording of the content, based on the received recording command.

The command may be a reproduction command for instructing the reproduction of content recorded on a recording medium, and the control means may control the device to be controlled and reproduce the content, based on the received reproduction command.

Reproduction location information indicating the reproduction location of the content may be attached to the reproduction command, and the control means may reproduce the content from the reproduction location based on the reproduction location information attached to the reproduction command.

The command may be a volume setting command for instructing a change of the volume, and the control means may control the device to be controlled and change the volume of audio output from the device to be controlled, based on the volume setting command.

According to another embodiment of the present invention, there is provided a control method of a control device connected to another control device through a network, the control device including: transmission means, reception means and control means, the control method including the steps of: through the network by the transmission means; receiving the command transmitted from the another control device through the network by the reception means; and controlling a device to be controlled connected through an integrated cable, in which at least a video line, an audio line and a control line are integrated, based on the received command, by the control means.

According to further another embodiment of the present invention, there is provided a program for enabling the computer of a control device connected to another device through a network to function as: transmission means configured to transmit a command to the another control device through the network; reception means configured to receive the command transmitted from the another control device through the network; and control means configured to control a device to be controlled connected through an integrated cable, in which at least a video line, an audio line and a control line are integrated, based on the received command.

According to the embodiments of the present invention, the command transmitted from another control device through the network is received, and the device to be controlled connected through the integrated cable, in which at least the video line, the audio line and the control line are integrated, is controlled based on the received command.

According to the embodiments of the present invention, it is possible to control the device to be controlled connected through the network.

### BRIEF DESCRIPTION OF THE DRAWINGS

FIG. 1 is a block diagram showing a configuration example of a control system to which the present invention is applied;

FIG. 2 is a block diagram showing a configuration example of a control device;

FIG. 3 is a first diagram showing an example of communication performed with a control device;

FIG. 4 is a flowchart illustrating a record request process of requesting record to another control device at a control device;

FIG. 5 is a flowchart illustrating a record process of controlling record start according to a request from a control device at another control device;

FIG. 6 is a second diagram showing an example of communication performed with a control device;

FIG. 7 is a diagram showing a display example of a display screen for selecting a room for continuously viewing content;

FIG. 8 is a flowchart illustrating a reproduction request process of requesting reproduction to another control device at a control device;

FIG. 9 is a flowchart illustrating a reproduction process of controlling reproduction according to a request from a control device at another control device;

FIG. 10 is a third diagram showing an example of communication performed with a control device;

FIG. 11 is a fourth diagram showing an example of communication performed with a control device; and

FIG. 12 is a block diagram showing a configuration example of a computer.

### DESCRIPTION OF THE PREFERRED EMBODIMENTS

Hereinafter, a mode (hereinafter, referred to as the present embodiment) for carrying out the present invention will be described. In addition, the description will be given in the following order.

1. Present Embodiment (Example of Controlling Device to be controlled Connected to Another Control Device at Control Device)

2. Modified Example

### 1. Present Embodiment

### Configuration Example of Control System 1

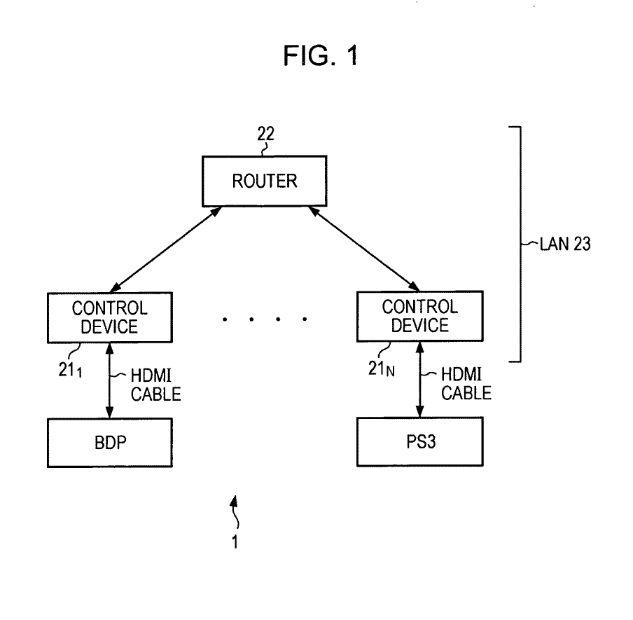

FIG. 1 is a block diagram showing a configuration example of a control system 1 to which the present invention is applied.

The control system 1 includes, for example, control devices 21₁ to 21_{N} such as a television receiver or the like, which are connected through a router 22, the router 22, and devices to be controlled connected to the control devices 21₁ to 21_{N} through HDMI cables.

In addition, the control system 1 is established in, for example, a house. In detail, for example, the control devices 21₁ to 21_{N} are installed in a plurality of rooms of the house, respectively. In addition, the control devices 21₁ to 21_{N} are connected to the router 22 installed in the house through 100BASE-T cables or the like, or wirelessly so as to form a Local Area Network (LAN) 23 such as Ethernet (trademark).

Here, the Ethernet indicates a LAN standardized in IEEE (Institute of Electrical and Electronics Engineers) 802.3.

In the following description, if it is not necessary to identify the control devices 21₁ to 21_{N} respectively, the control devices 21₁ to 21_{N} are merely called control devices 21.

The control device 21 has an HDMI terminal for connecting the device to be controlled such as a Blu-ray Disc (BD) Player (BDP), an Audio Visual (AV) Receiver (not shown), a Playstation 3 (PS3) (trademark) and a digital video camera (not shown) through the HDMI cable, and is connected to the device to be controlled if necessary.

In addition, the control device 21 controls the device to be controlled connected through the HDMI cable according to a user operation performed for controlling the device to be controlled, if the device to be controlled is connected.

In addition, the control device 21 communicates data with another control device 21 each other through the router 22 of the LAN 23.

That is, for example, the control device 21ₓ transmits a command for controlling a device to be controlled connected to another control device 21_{y} to another control device 21_{y} through the router 22 according to a user operation performed for controlling the device to be controlled connected to another control device 21_{y}. In addition, x and y are different values in a range from 1 to N with each other.

In this case, the control device 21_{y} receives the command transmitted from another control device 21ₓ through the router 22 and controls the device to be controlled connected to the control device 21_{y} based on the received command.

The router 22 is connected to each control device 21 so as to mediate the exchange of the command between the control devices 21.

In addition, as the control device 21, if it may be connected to the router 22, for example, a personal computer, a television receiver or the like may be used.

Accordingly, in the following description, it is assumed that the control device 21 is a television receiver which may be connected to the router 22. In addition, since the control devices 21 are similarly configured, only the configuration of the control device 21ₓ will be described and the description of the configuration of another control device 21 will be omitted.

### Configuration Example of Control Device 21ₓ

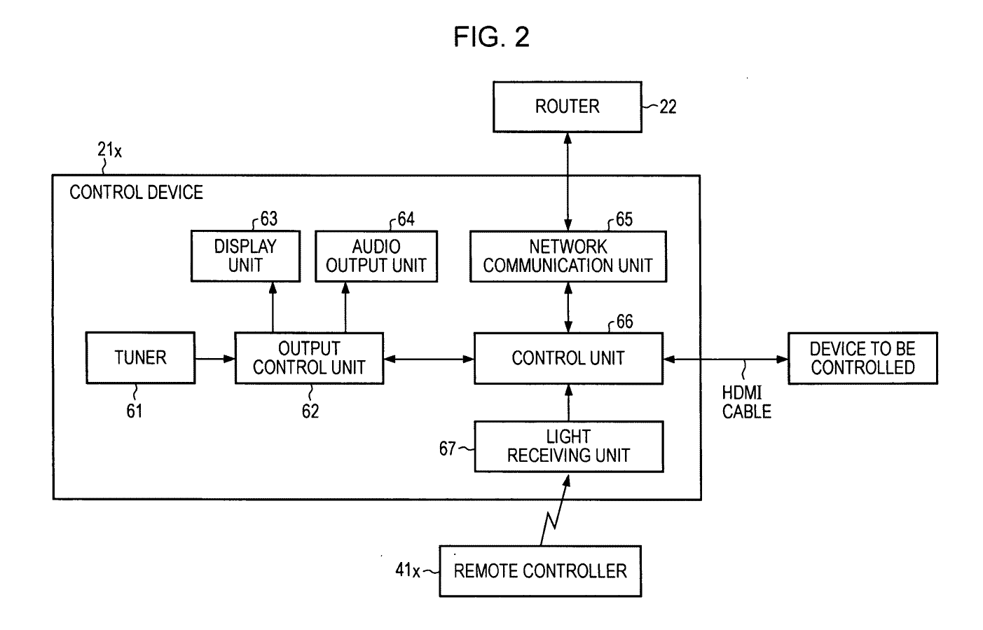

FIG. 2 is a block diagram showing a configuration example of a television receiver as a control device 21ₓ.

The control device 21ₓ includes a tuner 61, an output control unit 62, a display unit 63, an audio output unit 64, a network communication unit 65, a control unit 66 and a light receiving unit 67. In addition, the control device 21ₓ performs an operation according to an operation signal from a dedicated remote controller 41ₓ.

The tuner 61 receives broadcast signals supplied from an antenna (not shown), demodulates an image signal and an audio signal from the broadcast signal of a predetermined channel (frequency band) among the received broadcast signals, and supplies the signals to the output control unit 62.

The output control unit 62 supplies the image signal from the tuner 61 to the display unit 63 and displays an image corresponding thereto. In addition, the output control unit supplies the audio signal from the tuner 61 to the audio output unit 64 and outputs audio corresponding thereto.

The display unit 63 includes, for example, a Liquid Crystal Display (LCD) or the like and displays the image corresponding to the image signal from the output control unit 62.

The audio output unit 64 includes, for example, a speaker or the like and outputs the audio corresponding to the audio data from the output control unit 62.

The network communication unit 65 transmits a command for controlling the device to be controlled connected to another control device 21_{y} to another control device 21_{y} through the router 22, as a command supplied from the below-described control unit 66.

In addition, the network communication unit 65 receives, for example, a command for controlling the device to be controlled connected to the control device 21ₓ as a command transmitted from another control device 21_{y} through the router 22. In addition, the network communication unit 65 supplies the received command to the control unit 66.

The control unit 66 controls the device to be controlled connected through the HDMI cable through a CEC line included in the HDMI cable, according to the command from the network communication unit 65. In addition, the CEC line is one of signal lines included in the HDMI cable and is a signal line which is able to perform bidirectional communication with the device to be controlled.

In addition, the control unit 66 controls the tuner 61, the output control unit 62, the network communication unit 65, and the device to be controlled, for example, based on an operation signal from the light receiving unit 67.

In addition, the control unit 66 generates a command for controlling the device to be controlled connected to another control device 21_{y} based on the operation signal from the light receiving unit 67. The control unit 66 supplies the generated command to the network communication unit 65.

The light receiving unit 67 receives the operation signal from the remote controller 41ₓ and supplies the operation signal to the control unit 66.

According to the control system 1, since the plurality of control devices 21 are connected to each other by the router 22, for example, the control device 21ₓ may control another control device 21_{y} through the router 22.

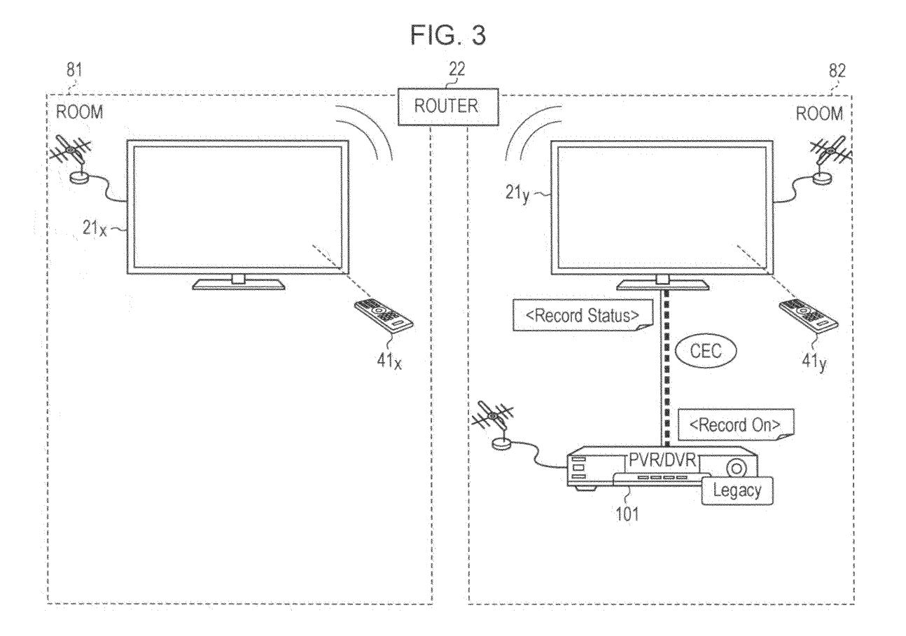

Next, an example in which, for example, the control device 21ₓ controls another control device 21_{y} and executes the recording of predetermined content in the recording and reproduction device 101 connected to another control device 21_{y} will be described with reference to FIGS. 3 to 5.

Example in which Control Device 21ₓ Controls Another Control Device 21_{y}

FIG. 3 shows an example of communication performed between the control device 21ₓ and the control device 21_{y} among the plurality of control devices 21₁ to 21_{N} configuring the control system 1.

In addition, in FIG. 3, the control device 21ₓ is installed in a room 81 of a house.

In addition, in FIG. 3, the control device 21_{y} is installed in a room 82 of the house in a state in which the recording and reproduction device 101 is connected as the device to be controlled connected through the HDMI cable.

The recording and reproduction device 101 includes, for example, a hard disk, records content on the hard disk mounted therein or reproduces content from the hard disk, and generally corresponds to a Personal Video Recorder (PVR) or a Digital Video Recorder (DVR).

For example, the control device 21ₓ receives the operation signal supplied from the remote controller 41ₓ according to the operation of the remote controller 41ₓ such that the user of the control system 1 records the content which is being viewed in the control device 21ₓ in the recording and reproduction device 101 connected to the control device 21_{y}.

In addition, the control device 21ₓ generates a <Record request> command for requesting the recording of the content which is being displayed by the control device 21ₓ in the recording and reproduction device 101 connected to the control device 21_{y} based on the operation signal received from the remote controller 41ₓ. In addition, the control device 21ₓ transmits the generated <Record request> command to the control device 21_{y} through the router 22.

In addition, the control device 21ₓ receives a <Record Status> command with recording status information attached indicating the recording status as a command transmitted from the control device 21_{y} through the router 22 in correspondence with the transmission of the <Record request> command.

The control device 21ₓ displays information indicating the recording status on a display screen (the display unit 63 of FIG. 2) based on the recording status information attached to the received <Record Status> command.

The control device 21_{y} receives the <Record request>command transmitted from the control device 21ₓ through the router 22. In addition, the control device 21_{y} generates a <Record On> command for recording the content which is being displayed by the control device 21ₓ, based on the received <Record request> command.

The control device 21_{y} notifies the recording and reproduction device 101 of the generated <Record On> command through the CEC line of the HDMI cable.

In this case, the recording and reproduction device 101 starts the recording of the content which is being displayed by the control device 21ₓ, based on the <Record On>command sent from the control device 21_{y} through the CEC line. In addition, the recording and reproduction device 101 generates the <Record Status> command with the recording status information attached indicating the recording status (for example, whether or not the recording is normally performed) based on the <Record On> command, and notifies the control device 21_{y} of the <Record Status> command through the CEC line.

The control device 21_{y} receives the <Record Status>command notified from the recording and reproduction device 101 through the CEC line of the HDMI cable and transmits the <Record Status> command to the control device 21ₓ through the router 22.

### Description of Operation of Control Device 21ₓ of FIG. 3

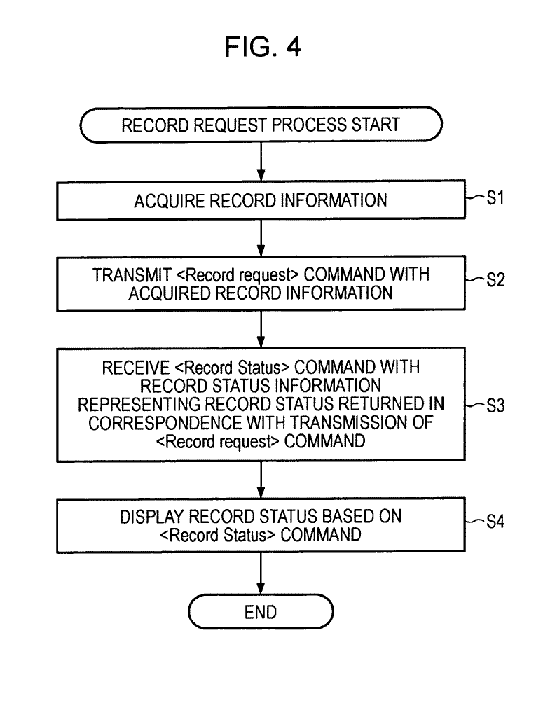

Next, a record request process performed by the control device 21ₓ of FIG. 3 will be described with reference to the flowchart of FIG. 4.

The recording request process is started, for example, when the user operates the remote controller 41ₓ such that the content which is being viewed in the control device 21ₓ is recorded in the recording and reproduction device 101 connected to another control device 21_{y}.

At this time, the light receiving unit 67 of the control device 21ₓ receives the operation signal from the remote controller 41ₓ and supplies the operation signal to the control unit 66.

In step S1, the control unit 66 acquires record information indicating a channel number, a broadcast station or the like for specifying the content (content which is being displayed by the control device 21ₓ), of which the recording is instructed, from the tuner 61 through the output control unit 62, based on the operation signal from the light receiving unit 67.

In step S2, the control unit 66 generates the <Record request> command with the acquired record information attached. In addition, the control unit 66 establishes Internet Protocol (IP) packets including the generated <Record request> command using a program language such as an Extensible Markup Language (XML) and supplies the packets to the network communication unit 65.

The network communication unit 65 transmits the IP packets from the control unit 66 to the control device 21_{y} through the router 22.

In this case, the control device 21_{y} controls the recording and reproduction device 101 and performs the recording process of executing the recording of the content, in correspondence with the reception of the IP packets from the router 22.

That is, for example, the control device 21_{y} receives the IP packets from the router 22, controls the recording and reproduction device 101 based on the <Record request> command included in the received IP packets, and executes the recording of the content. In addition, the control device 21_{y} establishes the IP packets including the <Record Status>command with the recording status information attached indicating the recording status by the recording and reproduction device 101 and transmits the IP packets to the control device 21ₓ through the router 22.

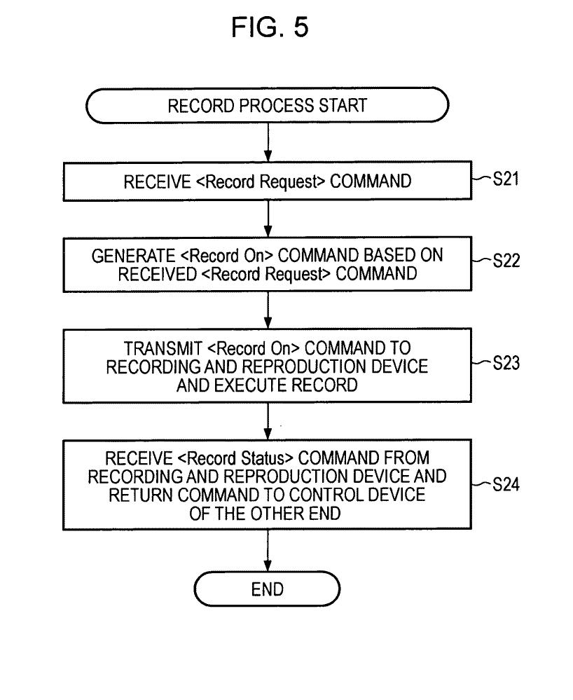

In addition, the details of the recording process performed by the control device 21_{y} will be described later with reference to the flowchart of FIG. 5.

In step S3, the network communication unit 65 receives the IP packets (including the <Record Status>command) transmitted from the control device 21_{y} through the router 22 and supplies the IP packets to the control unit 66.

In step S4, the control unit 66 supplies the recording status information attached to the <Record Status> command to the output control unit 62 based on the <Record Status> command included in the IP packets from the network communication unit 65, and displays the recording status indicating the recording status information on the display unit 63. Then, the recording request process is finished.

### Description of Operation of Control Device 21_{y} of FIG. 3

Next, the recording process performed by the control device 21_{y} of FIG. 3 will be described with reference to the flowchart of FIG. 5.

The recording process is started, for example, when the IP packets including the <Record request> command are transmitted from the control device 21ₓ in correspondence with the recording request process performed by the control device 21ₓ of FIG. 3.

In step S21, the network communication unit 65 of the control device 21_{y} receives the IP packets (including the <Record request> command) transmitted from the control device 21ₓ through the router 22 and supplies the IP packets to the control unit 66.

In step S22, the control unit 66 generates the <Record On> command with the recording information attached which is attached to the <Record request> command as a parameter, based on the <Record request> command included in the IP packets from the network communication unit 65.

In step S23, the control unit 66 notifies the recording and reproduction device 101 of the generated <Record On> command through the CEC line of the HDMI cable and executes the record. In this case, the recording and reproduction device 101 starts the recording of the content specified by the recording information attached to the <Record On> command, based on the <Record On> command from the control unit 66.

In addition, the recording and reproduction device 101 appropriately generates the <Record Status> command with the recording status information attached indicating the recording status as a parameter and notifies the control unit of the <Record Status> command, after the recording is started.

In step S24, the control unit 66 establishes the IP packets including the <Record Status> command from the recording and reproduction device 101 and supplies the IP packets to the network communication unit 65. The network communication unit 65 transmits the IP packets from the control unit 66 to the control device 21_{y} through the router 22. Then, the recording process is finished.

As described above, according to the recording request process, the control device 21ₓ transmits the <Record request> command to the control device 21_{y} through the router 22.

In the recording process, the control device 21_{y} starts the recording of the recording and reproduction device 101, based on the <Record request> command transmitted from the control device 21ₓ through the router 22.

To this end, the control device 21ₓ may control the device to be controlled (the recording and reproduction device 101) connected through the router 22, another control device 21_{y} and the HDMI cable in addition to the device to be controlled connected to the control device 21ₓ through the HDMI cable.

In addition, in FIG. 3, the control device 21_{y} exchanges the command with the recording and reproduction device 101 by the HDMI CEC control of the related art for transmitting and receiving the command through the CEC line.

Accordingly, in FIG. 3, the control device 21ₓ may control the recording and reproduction device 101 connected to the control device 21_{y}, without changing the recording and reproduction device 101 of the related art at all.

Another Example in which Control Device 21ₓ Controls Another Control Device 21_{y}

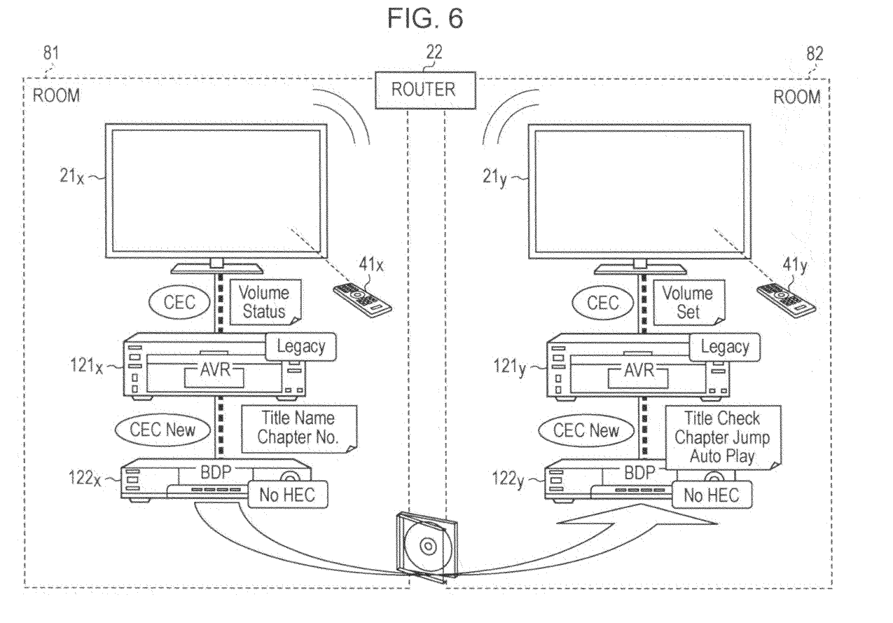

Next, an example of communication performed between the control device 21ₓ and the control device 21_{y} such that, for example, when a disc (for example, Blu-ray disc) on which content is recorded is reproduced in the room 81, the reproduction is stopped and the disc is taken out and, when the disc is reproduced in the room 82, continuation of the content which has been viewed by reproducing the disc in the room 81 is viewed in the room 82 will be described with reference to FIGS. 6 to 9.

FIG. 6 is a diagram showing another example of communication performed between the control device 21ₓ and the control device 21_{y} among the plurality of control devices 21₁ to 21_{N} configuring the control system 1.

In addition, in FIG. 6, the control device 21ₓ, the AV receiver (AVR) 121ₓ and the BD player (BDP) 122ₓ are connected to each other through the HDMI cable. In addition, the control device 21_{y}, the AV receiver (AVR) 121_{y} and the BD player (BDP) 122_{y} are connected to each other through the HDMI cable. The other configuration is equal to that of FIG. 3.

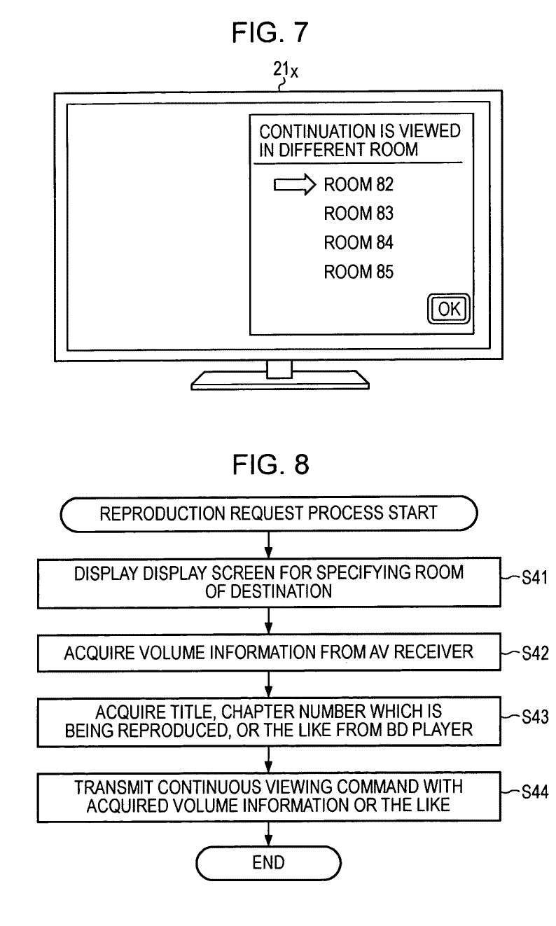

The control device 21ₓ displays an image corresponding to an image signal of content supplied from the BD player 122ₓ. In addition, the control device 21ₓ displays a display screen for selecting a room for continuously viewing the content, as shown in FIG. 7, according to a user operation performed for continuously viewing the content, which has been viewed in the room 81, in another room.

When the user performs a selection operation for selecting, for example, a room 82 from among the rooms 82 to 85 of the house from the display screen shown in FIG. 7 using the remote controller 41ₓ, the remote controller 41ₓ transmits an operation signal according to the selection operation of the user to the control device 21ₓ.

The control device 21ₓ generates a <Get Audio Status>command for requesting volume information indicating the volume of the audio output from the AV receiver 121ₓ or the like according to the operation signal from the remote controller 41ₓ, and notifies the AV receiver 121ₓ of the command through the CEC line.

Then, the control device 21ₓ receives a <Report Audio Status> command with the volume information attached or the like as the parameter from the AV receiver 121ₓ in correspondence with the notification of the <Get Audio Status>command.

In addition, the control device 21ₓ generates a reproduction information request command for requesting reproduction information including a title of content which is being reproduced, a chapter number indicating the reproduction location of the content which is being reproduced, or the like from the BD player 122ₓ and notifies the BD player 122ₓ of the reproduction information request command through the CEC line, according to the operation signal from the remote controller 41ₓ.

Then, the control device 21ₓ receives a reproduction information response command attached the reproduction information with from the BD player 122ₓ in correspondence with the notification of the reproduction information request command.

In addition, although the exchange of the command performed through the CEC line between the control device 21ₓ and the BD player 122ₓ is not defined in the current HDMI specification, the HDMI cable for connecting the control device 21ₓ and the BD player 122ₓ, which performs HDMI CEC control for performing the transmission/reception of the command between the control device 21ₓ and the BD player 122ₓ in the CEC line of the HDMI cable, is employed.

The same is true in the below-described HDMI cable for connecting to the control device 21_{y} and the BD player 122_{y}.

The control device 21ₓ extracts the volume information attached to the <Report Audio Status> command received from the AV receiver 121ₓ and the reproduction information attached to the reproduction information response command received from the BD player 122ₓ.

In addition, the control device 21ₓ generates a continuous viewing command with the extracted volume information attached and reproduction information as the parameter. In addition, the control device 21ₓ generates IP packets including the generated continuous viewing command by XML or the like and transmits the IP packets to the control device 21_{y} through the router 22.

The AV receiver 121ₓ receives the audio signal from the BD player 122ₓ and outputs audio corresponding to the received audio signal.

In addition, the AV receiver 121ₓ generates a <Report Audio Status> command with the volume information attached indicating the volume of the audio output from the AV receiver 121ₓ as the parameter and notifies the control device 21ₓ of the command through the CEC line, based on the <Get Audio Status> command notified from the control device 21ₓ through the CEC line.

The BD player 122ₓ reads and supplies an image signal corresponding to the content recorded in the disc inserted by the user to the control device 21ₓ through a Transition Minimized Differential Signaling (TMDS) line of the HDMI cable. In addition, the TMDS line is one of the signal lines included in the HDMI cable and indicates a signal line used to transmit an image audio signal (image signal or audio signal).

In addition, the BD player 122ₓ reads and supplies an audio signal corresponding to the content recorded in the disc inserted by the user to the AV receiver 121ₓ through the TMDS line of the HDMI cable.

In addition, the BD player 122ₓ generates a reproduction information response command with the reproduction information attached including a title of content which is being reproduced in the BD player 122ₓ, a chapter number, or the like and notifies the control device 21ₓ of the reproduction information response command through the CEC line, based on the reproduction information request command notified from the control device 21ₓ through the CEC line.

The control device 21_{y} receives the IP packets transmitted from the control device 21ₓ through the router 22 and displays, for example, a message such as “scheduled to be used in a moment” on the display screen if the received IP packets include the continuous viewing command.

The control device 21_{y} extracts the volume information and the reproduction information attached to the continuous viewing command from the continuous viewing command included in the received IP packets.

The control device 21_{y} generates a volume setting command for setting the volume of the audio output from the AV receiver 121_{y} to the volume indicated by the extracted volume information, based on the extracted volume information. In addition, the control device 21_{y} attaches the volume information to the generated volume setting command as the parameter and notifies the AV receiver 121_{y} of the volume setting command through the CEC line.

In addition, although the volume setting command is not defined in the current HDMI specification, in the present embodiment, a HDMI cable able to notify the AV receiver 121_{y} of the volume setting command through the CEC line is employed.

In addition, the control device 21_{y} generates a reproduction command for enabling the BD player 122_{y} to reproduce the disc inserted by the user from the chapter number included in the reproduction information, based on the extracted reproduction information. The control device 21_{y} attaches the reproduction information to the generated reproduction command as the parameter and notifies the BD player 122, of the reproduction command through the CEC line.

The AV receiver 121_{y} sets the volume of the output audio to the volume indicated by the volume information attached to the volume setting command, based on the volume setting command from the control device 21_{y}. In addition, the AV receiver 121_{y} outputs the audio corresponding to the audio signal from the BD player 122_{y} with the set volume.

The BD player 122_{y} determines whether the title of the disc inserted by the user matches to the title included in the reproduction information attached to the reproduction command, based on the reproduction command from the control device 21_{y}.

If it is determined that the title of the disc inserted by the user does not match to the title included in the reproduction information attached to the reproduction command based on the reproduction command from the control device 21_{y}, the BD player 122_{y} does not reproduce the disc inserted by the user and supplies the determined result to the control device 21_{y}.

In this case, the control device 21_{y} displays an indication that the disc to be inserted into the BD player 122_{y} is different, and displays an indication for prompting the insertion of the disc which has been reproduced by the BD player 122ₓ on the display screen.

In addition, when it is determined that the title of the disc inserted by the user matches to the title included in the reproduction information attached to the reproduction command based on the reproduction command from the control device 21_{y}, the BD player 122_{y} reproduces the disc inserted by the user from the chapter number included in the reproduction information attached to the reproduction command.

In addition, the BD player 122_{y} supplies the image signal of the content obtained by reproduction to the control device 21_{y} through the TMDS line and supplies the audio signal of the content obtained by reproduction to the AV receiver 121_{y} through the TMDS line.

### Description of Operation of Control Device 21ₓ of FIG. 6

Next, a reproduction request process performed by the control device 21ₓ of FIG. 6 will be described with reference to the flowchart of FIG. 8.

The reproduction request process is started, for example, when the user operates the remote controller 41ₓ so as to display the display screen shown in FIG. 7. At this time, the remote controller 41ₓ transmits the operation signal corresponding to the user operation to the control device 21ₓ.

In step S41, the light receiving unit 67 of the control device 21ₓ of FIG. 6 receives and supplies the operation signal from the remote controller 41ₓ to the control unit 66. The control unit 66 controls the output control unit and displays the display screen shown in FIG. 7 on the display unit 63, based on the operation signal from the light receiving unit 67.

In correspondence with the selection operation for selecting, for example, a room 82 from among the rooms 82 to 85 from the display screen shown in FIG. 7 by the user using the remote controller 41ₓ, the remote controller 41ₓ transmits the operation signal corresponding to the selection operation of the user to the light receiving unit 67 of the control device 21ₓ.

The light receiving unit 67 supplies the operation signal from the remote controller 41ₓ to the control unit 66. In this case, the control unit 66 controls the output control unit 62 in correspondence with the supply of the operation signal from the light receiving unit 67 and displays the display screen for prompting the user to remove the disc from the BD player 122ₓ and to insert the disc into the BD player 122, of the room 82 on the display unit 63.

In step S42, the control unit 66 generates a <Get Audio Status> command for requesting the volume information indicating the volume of the audio output from the AV receiver 121ₓ or the like and notifies the AV receiver 121ₓ of the <Get Audio Status> command through the CEC line, according to the operation signal from the light receiving unit 67.

Thus, the control unit 66 receives the <Report Audio Status> command with the volume information attached or the like from the AV receiver 121ₓ, in correspondence with the notification of the <Get Audio Status> command.

In step S43, the control unit 66 generates the reproduction information request command for requesting the reproduction information including the title of the content which is being reproduced, the chapter number indicating the reproduction location of the content which is being reproduced, or the like from the BD player 122ₓ and notifies the BD player 122ₓ of the reproduction information request command through the CEC line, according to the operation signal from the light receiving unit 67.

Thus, the control unit 66 receives the reproduction information response command with the reproduction information attached from the BD player 122ₓ, in correspondence with the notification of the reproduction information request command.

In step S44, the control unit 66 extracts the volume information attached to the <Report Audio Status> command received from the AV receiver 121ₓ and the reproduction information attached to the reproduction information response command received from the BD player 122ₓ.

In addition, the control unit 66 generates the continuous viewing command with the extracted volume information attached and reproduction information as the parameter. The control unit 66 generates and supplies the IP packets including the generated continuous viewing command by XML or the like to the network communication unit 65.

The network communication unit 65 transmits the IP packets from the control unit 66 to the control device 21_{y} of FIG. 6 through the router 22 under the control of the control unit 66. Then, the reproduction request process is finished. After the reproduction request process is finished, the control device 21ₓ may notify the AV receiver 121ₓ and the BD player 122ₓ connected using the HDMI cable of the transition to the low power consumption through the CEC line.

### Description of Operation of Control Device 21_{y} of FIG. 6

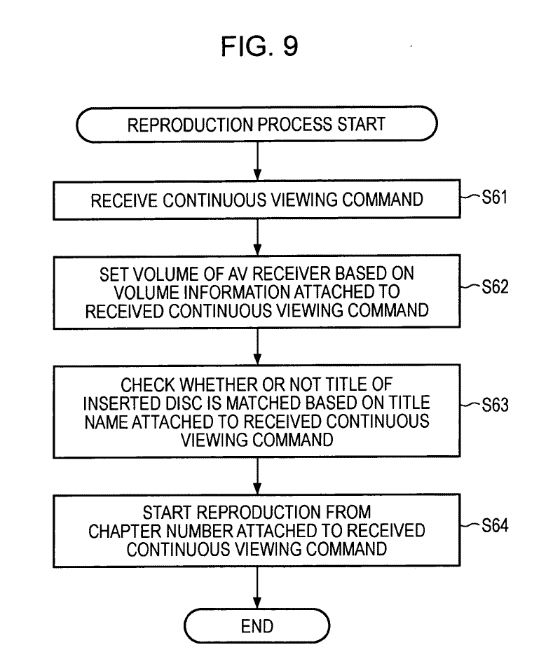

Next, a reproduction process performed by the control device 21_{y} of FIG. 6 will be described with reference to the flowchart of FIG. 9.

The reproduction process is started, for example, when the IP packets including the continuous viewing command are transmitted from the control device 21ₓ of FIG. 6 through the router 22.

In step S61, the network communication unit 65 of the control device 21_{y} of FIG. 6 receives and supplies the IP packets transmitted from the control device 21ₓ of FIG. 6 through the router 22 to the control unit 66.

The control unit 66 controls the output control unit 62 and displays, for example, a message such as “scheduled to be used in a moment” on the display unit 63, if the IP packets from the network communication unit 65 include the continuous viewing command. Thus, it is possible to prevent the control device 21_{y} of FIG. 6 from being used by another user.

In addition, if the control device 21_{y} is, for example, in a sleep state in which power supplied to the tuner 61, the audio output unit 64, and the like is restricted (blocked), the control unit 66 releases the sleep state, supplies sufficient power to the tuner 61, the audio output unit 64, and the like, controls the output control unit 62, and displays, for example, a message such as “scheduled to be used in a moment” on the display unit 63.

In addition, the control unit 66 extracts the volume information and the reproduction information attached to the continuous viewing command from the continuous viewing command included in the received IP packets.

In step S62, the control unit 66 generates the volume setting command for setting the volume of the audio output from the AV receiver 121_{y} to the volume indicated by the extracted volume information, based on the extracted volume information.

The control unit 66 attaches the volume information to the generated volume setting command as the parameter and notifies the AV receiver 121_{y} of the volume setting command through the CEC line so as to control the AV receiver 121_{y} such that the volume of the output audio is set to the volume indicated by the volume information attached to the volume setting command.

In step S63, the control unit 66 generates the reproduction command for enabling the BD player 122_{y} to reproduce the disc inserted by the user from the chapter number included in the reproduction information, based on the extracted reproduction information.

The control unit 66 attaches the reproduction information to the generated reproduction command and notifies the BD player 122_{y} of the reproduction information through the CEC line so as to control the BD player 122_{y} so as to determine whether or not the title of the disc inserted into the BD player 122, matches to the title included in the reproduction information included in the reproduction command.

If it is determined that the title included in the reproduction information attached to the reproduction command from the control unit 66 does not match to the title of the content recorded in the inserted disc, the control unit 66 performs, for example, the following process by the BD player 122_{y}.

That is, for example, the control unit 66 controls the output control unit 62, displays an indication on the display unit 63 that the disc to be inserted into the BD player 122, is different, and displays an indication prompting the insertion of the disc which has been reproduced by the BD player 122ₓ. The control unit 66 returns the process to step S63 and the same process is performed thereafter.

In addition, if it is determined that the title included in the reproduction information attached to the reproduction command from the control unit 66 matches to the title of the content recorded in the inserted disc, the control unit 66 progress the process to step S64 by the BD player 122_{y}.

In step S64, the control unit 66 controls the BD player 122, and reproduces the disc inserted into the BD player 122, from the chapter number included in the reproduction information attached to the reproduction command from the control unit 66.

In this case, the BD player 122_{y} reads the content recorded in the inserted disc from the chapter number included in the reproduction information. In addition, the BD player 122, supplies the image signal of the content read from the disc to the control unit 66 through the TMDS line.

The control unit 66 supplies the image signal from the BD player 122_{y} to the output control unit 62. In addition, the output control unit 62 supplies the image signal from the control unit 66 to the display unit 63 and displays the image corresponding to the image signal.

Further, the BD player 122_{y} supplies the audio signal of the content read from the disc to the AV receiver 121_{y} through the TMDS line. In addition, the AV receiver 121_{y} outputs the audio corresponding to the audio signal from the BD player 122, with the volume set in the process of step S62.

As described above, in the reproduction request process, the control device 21ₓ of FIG. 6 acquires the volume information from the AV receiver 121ₓ, acquires the reproduction information from the BD player 122ₓ, and transmits the continuous viewing command with the acquired volume information attached and reproduction information as the parameter to the control device 21_{y} of FIG. 6.

In the reproduction process, the control device 21_{y} of FIG. 6 sets the volume of the AV receiver 121_{y} to the volume of the AV receiver 121ₓ and continuously reproduce the content which has been reproduced in the BD player 122ₓ by the BD player 122_{y} based on the continuous viewing command supplied from the control device 21ₓ of FIG. 6 through the router 22.

Accordingly, the user may continuously view the content, which has been viewed in the room 81, in the room 82 in the same viewing environment as that of the room 81.

In addition, in the reproduction process, in step S63, the control unit 66 controls the BD player 122_{y} and determines whether the title of the disc inserted into the BD player 122, matches to the title included in the reproduction information attached to the reproduction command.

Accordingly, it is possible to prevent a disc, on which content different from that of the disc taken out from the BD player 122ₓ of FIG. 6 is recorded, from being inserted and reproduced by the BD player 122_{y}.

In addition, in the reproduction process, the process of step S63 may be omitted. In this case, the reproduction process may be more rapidly performed.

In addition, in FIG. 6, the control device 21ₓ exchanges the command with the device to be controlled connected through the HDMI cable by the HDMI CEC control of the related art for transmitting and receiving the command through the CEC line.

Accordingly, in FIG. 6, by adding a couple of countermeasures to new commands to the AV receiver 121ₓ and the BD player 122ₓ of the related art, the control device 21ₓ is able to control the AV receiver 121ₓ and the BD player 122ₓ connected to the control device 21ₓ. The same is true in the control device 21_{y}, the AV receiver 121_{y} and the BD player 122_{y} of FIG. 6.

In addition, the control device 21ₓ of FIG. 6 transmits the volume information acquired from the AV receiver 121ₓ and the reproduction information acquired from the BD player 122ₓ to the control device 21_{y} through the router 22 as the parameter attached to the continuous viewing command.

To this end, the AV receiver 121ₓ may directly transmit the volume information to the control device 21_{y} through the router 22 and the BD player 122ₓ may not transmit the reproduction information to the control device 21_{y} through the router 22.

Accordingly, the AV receiver 121ₓ and the BD player 122, may not have a function for performing communication with the control device 21_{y} through the router 22. The same is true in the AV receiver 121_{y} and the BD player 122_{y} connected to the control device 21_{y} of FIG. 6.

### 2. Modified Example

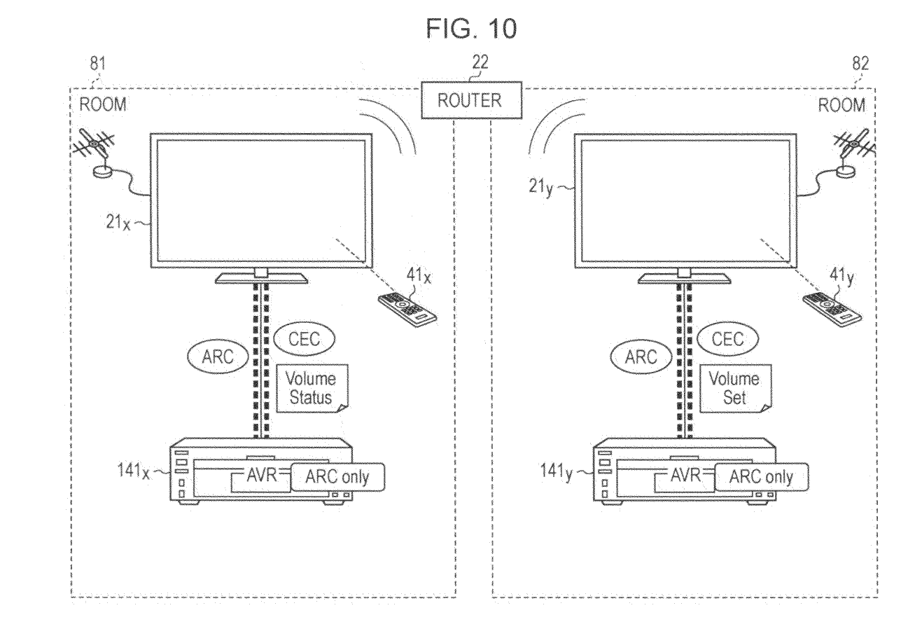

Although, in the present embodiment, for example, the example in which the control device 21ₓ controls another control device 21_{y} and executes the predetermined process is described with reference to FIGS. 3 to 9, for example, as shown in FIG. 10, the control device 21ₓ may control another control device 21_{y} such that the viewing environment of the content in the room 82 becomes equal to the viewing environment of the content in the room 81.

Next, FIG. 10 shows an example in which the control device 21ₓ installed in the room 81 controls the control device 21_{y} installed in the room 82 such that the viewing environment of the content in the room 82 becomes equal to the viewing environment of the content in the room 81.

In addition, in FIG. 10, the control device 21ₓ displays the content received by the tuner 61, and is installed in the room 81 of the house in a state in which the AV receiver 141ₓ is connected through the HDMI cable as the device to be controlled. The audio signal of the image signal and the audio signal selected by the tuner 61 of the control device 21ₓ and sent to the output control unit 62 is supplied from the control device 21ₓ to the AV receiver 141ₓ through an Audio Return Channel (ARC) line of the HDMI cable. In addition, the ARC line is one of the signal lines included in the HDMI cable and indicates a signal line used to transmit the audio signal in a direction opposed to that of the TMDS line.

In addition, in FIG. 10, the control device 21_{y} is installed in the room 82 of the house in a state in which the AV receiver 141_{y} is connected as the device to be controlled connected through the HDMI cable. The audio signal of the image signal and the audio signal selected by the tuner 61 and sent to the output control unit 62 is supplied from the control device 21_{y} to the AV receiver 141_{y} through the ARC line of the HDMI cable.

The control device 21ₓ controls another control device 21_{y} when the operation signal transmitted from the remote controller 41ₓ is received, in correspondence with the operation for setting the viewing environment of the content in the room 82 to become equal to the viewing environment of the content in the room 81, which has been performed by the user using the remote controller 41ₓ.

That is, for example, the control device 21ₓ acquires the volume information indicating the volume of the audio output from the AV receiver 141ₓ through the CEC line according to the operation signal from the remote controller 41ₓ. In addition, the control device 21ₓ acquires the channel number for specifying the content which is being displayed or the like from the tuner 61 mounted therein.

In addition, the control device 21ₓ generates and transmits an environment setting command for setting the viewing environment of the room 82 to become equal to the viewing environment of the room 81 to the control device 21_{y} through the router 22, as an environment setting command with the acquired volume information attached and channel number and the like as the parameter.

The control device 21_{y} controls the AV receiver 141, through the CEC line based on the environment setting command transmitted from the control device 21ₓ through the router 22 and sets the volume of the audio output from the AV receiver 141_{y} to the volume (the volume of the audio output from the AV receiver 141ₓ) indicated by the volume information attached to the environment setting command.

In addition, the control device 21_{y} displays the content (content which has been displayed by the control device 21ₓ) specified by the channel number attached to the environment setting command and the like, based on the environment setting command transmitted from the control device 21ₓ through the router 22.

Thus, the viewing environment of the room 82 becomes equal to the viewing environment of the room 81.

Although, in the present embodiment, in FIG. 6, the control device 21ₓ controls the reproduction of the BD player 122, connected to the control device 21_{y} based on the reproduction information acquired from the BD player 122ₓ through the CEC line, the present invention is not limited thereto.

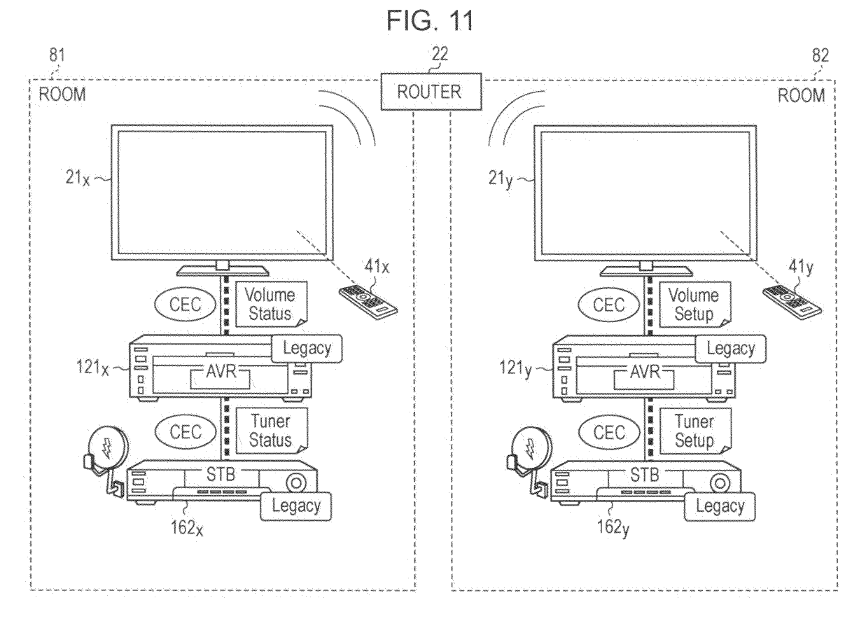

That is, for example, as shown in FIG. 11, if a set top box 162ₓ for selecting the content displayed by the control device 21ₓ is installed instead of the BD player 122ₓ of the room 81 and a set top box 162, for selecting the content displayed by the control device 21_{y} is installed instead of the BD player 122, of the room 82, the control device 21ₓ may control the selection of the set top box 162_{y} connected to the control device 21_{y} based on the selection information acquired from the set top box 162ₓ through the CEC line.

Although, in the present embodiment, in FIG. 3, for example, the content which is being displayed by the control device 21ₓ is recorded by the recording and reproduction device 101 in the room 82 in correspondence with the operation which has been performed by the user using the remote controller 41ₓ for recording the content which is being displayed by the control device 21ₓ in the room 81, the present invention is not limited thereto.

That is, for example, in FIG. 3, if the user displays an Electronic Program Guide (EPG) on the control device 21ₓ of the room 81 and reserves the recording of predetermined content, similarly, the predetermined content, for which the recording is reserved, may be recorded by the recording and reproduction device 101 of the room 82.

In addition, for example, the control device 21ₓ of FIG. 3 may reproduce content recorded in the hard disk mounted in the recording and reproduction device 101 from a predetermined reproduction location. In detail, for example, the control device 21ₓ of FIG. 3 generates a command for reproducing the content recorded in the hard disc mounted in the recording and reproduction device 101 and attaches the predetermined reproduction location thereto as the parameter. In addition, the control device 21ₓ transmits the command with the predetermined reproduction location attached as the parameter to the control device 21_{y} through the router 22 so as to control the recording and reproduction device 101 such that the content is reproduced by the control device 21_{y} from the predetermined reproduction location.

In addition, although, in the present embodiment, in FIG. 6, the control device 21ₓ controls the control device 21_{y} based on the volume information acquired from the AV receiver 121ₓ through the CEC line so as to set the volume of the AV receiver 121, connected to the control device 21_{y} to the volume indicated by the volume information, the present invention is not limited thereto.

That is, for example, in FIG. 6, if the AV receiver 121, is not connected to but only the BD player 122_{y} is connected to the control device 21_{y}, the control device 21ₓ may control the control device 21_{y} as the television receiver based on the volume information acquired from the AV receiver 121ₓ through the CEC line so as to the volume of the audio output from the control device 21_{y} to the volume indicated by the audio information.

Although, in the present embodiment, the LAN 23 is established by the plurality of control devices 21 and the router 22 and, for example, the control device 21ₓ controls the control device 21_{y} through (the router 22 of) the LAN 23, the present invention is not limited thereto.

That is, for example, in a network such as a Wide Area Network (WAN) including a set of a plurality of LANs or the Internet, the control device 21ₓ which establishes a predetermined LAN among the plurality of LANs may control the control device 21_{y} which establishes another LAN through the network such as the WAN or the Internet.

The above-described series of processes may be executed by dedicated hardware or software. If the series of processes is executed by the software, a program configuring the software is installed from a recording medium in a so-called assembly type computer or, for example, a general-purpose personal computer capable of executing various functions by installing various programs.

### Configuration Example of Computer

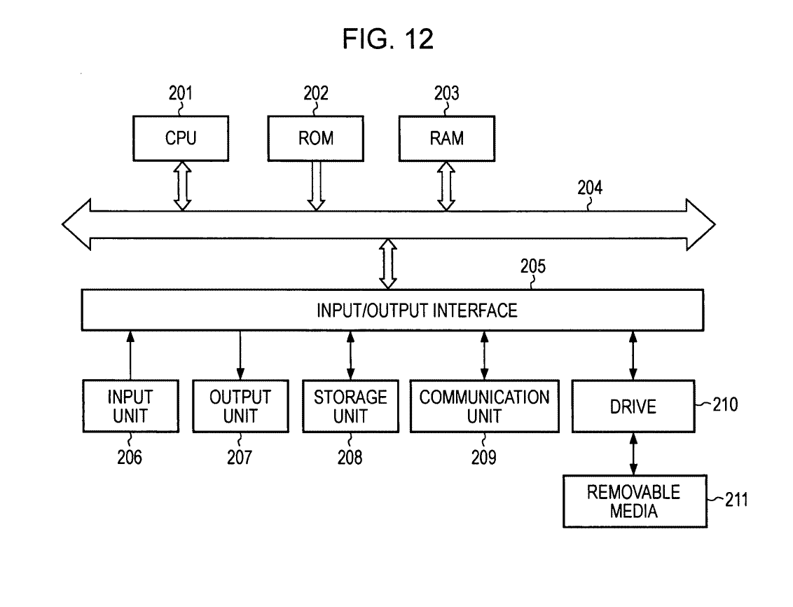

Next, FIG. 12 shows a configuration example of a computer for executing the above-described series of processes by a program.

A Central Processing Unit (CPU) 201 executes various processes according to a program stored in a Read Only Memory (ROM) 202 or a storage unit 208. A program, data or the like executed by the CPU 201 is appropriately stored in a Random Access Memory (RAM) 203. The CPU 201, the ROM 202 and the RAM 203 are connected to each other by a bus 204.

An input/output interface 205 is connected to the CPU 201 through the bus 204. An input unit 206 including a keyboard, a mouse, a microphone and the like and an output unit 207 including a display, a speaker and the like are connected to the input/output interface 205. The CPU 201 executes various processes in correspondence with an instruction input from the input unit 206. In addition, the CPU 201 outputs the processed result to the output unit 207.

The storage unit 208 connected to the input/output interface 205 includes, for example, a hard disk and stores the program executed by the CPU 201 or a variety of data. A communication unit 209 communicates with an external device through a network such as the Internet or a local area network.

In addition, the program may be acquired through the communication unit 209 so as to be stored in the storage unit 208.

When a removable media 211 such as a magnetic disc, an optical disc, a magneto-optical disc or a semiconductor memory is mounted, a drive 210 connected to the input/output interface 205 drives the media and acquires a program, data or the like recorded therein. The acquired program or data is transmitted to and stored in the storage unit 208 as necessary.

A recording medium for recording (storing) a program installed in a computer and executed by the computer includes a removable media 211 which is a package media including a magnetic disc (including a flexible disc), an optical disc (including a CD-ROM (Compact Disc-Read Only Memory) and a Digital Versatile Disc (DVD)), a magneto-optical disc (including a MD (Mini-Disc)) or a semiconductor memory, or the hard disk configuring the ROM 202 or the storage unit 208 for temporarily or permanently storing the program, as shown in FIG. 12. The recording of the program in the recording medium is performed using a wired or wireless communication medium such as a local area network, the Internet, a digital satellite broadcast through the communication unit 209 which is an interface such as a router, a modem or the like as necessary.

In addition, in the present specification, the steps of describing the above-described series of processes may be performed in time series according to the described order or may be executed in parallel or individually without processed in time series.

In the present specification, the system indicates all the devices including the plurality of devices.

In addition, the embodiment of the present invention is not limited to the above-described embodiment and various modifications are made without departing from the scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A control device connected to another control device through a network, the control device comprising:
transmission means configured to transmit a command to the another control device through the network;
reception means configured to receive the command transmitted from the another control device through the network; and
control means configured to control a device to be controlled connected through an integrated cable, in which at least a video line, an audio line and a control line are integrated, based on the received command.

2. The control device according to claim 1, wherein the network is a Local Area Network (LAN) and the reception means receives the command transmitted from the another control device through the LAN.

3. The control device according to claim 2, wherein the integrated cable is a High-Definition Multimedia Interface (HDMI) cable, and the control means controls the device to be controlled through a Consumer Electronics Control (CEC) line of the HDMI cable based on the received command.

4. The control device according to claim 3, wherein the command is a recording command for instructing the recording of content, and the control means controls the device to be controlled and starts the recording of the content, based on the received recording command.

5. The control device according to claim 3, wherein the command is a reproduction command for instructing the reproduction of content recorded in a recording medium, and the control means controls the device to be controlled and reproduces the content, based on the received reproduction command.

6. The control device according to claim 5, wherein reproduction location information indicating a reproduction location of the content is attached to the reproduction command, and the control means reproduces the content from the reproduction location based on the reproduction location information attached to the reproduction command.

7. The control device according to claim 3, wherein the command is a volume setting command for instructing the change of the volume, and the control means controls the device to be controlled and changes the volume of audio output from the device to be controlled, based on the received volume setting command.

8. A control method of a control device connected to another control device through a network, the control device including transmission means, reception means and control means, the control method comprising the steps of:
transmitting a command to the another control device through the network by the transmission means;
receiving the command transmitted from the another control device through the network by the reception means; and
controlling a device to be controlled connected through an integrated cable, in which at least a video line, an audio line and a control line are integrated, based on the received command, by the control means.

9. A program for enabling a computer of a control device connected to another device through a network to function as:
transmission means configured to transmit a command to the another control device through the network;
reception means configured to receive the command transmitted from the another control device through the network; and
control means configured to control a device to be controlled connected through an integrated cable, in which at least a video line, an audio line and a control line are integrated, based on the received command.

10. A control device connected to another control device through a network, the control device comprising:
a transmission unit configured to transmit a command to the another control device through the network;
a reception unit configured to receive the command transmitted from the another control device through the network; and
a control unit configured to control a device to be controlled connected through an integrated cable, in which at least a video line, an audio line and a control line are integrated, based on the received command.
